(19) United States
(12) Patent Application Publication
(10) Pub. No.: US 2003/0135729 A1
(43) Pub. Date: Jul. 17, 2003

(54) Apparatus and meta data caching method for optimizing server startup performance

(75) Inventors: Robert S. Mason JR., Uxbridge, MA (US); Brian L. Garrett, Hopkinton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: I/O Integrity, Inc., Medway, MA

(21) Appl. No.: 10/319,170

(22) Filed: Dec. 13, 2002

Related U.S. Application Data
(60) Provisional application No. 60/340,344, filed on Dec. 14, 2001.
(60) Provisional application No. 60/340,656, filed on Dec. 14, 2001.

(51) Int. Cl. G06F 12/00

(52) U.S. Cl. 713/2; 711/113; 711/103

(57) ABSTRACT

A technique that provides faster startup functionality for personal computers (PCs) and servers. Data requested by a host processor from a mass storage device, such as a disk drive, during a boot or start-up sequences is detected. Meta-data that describes the requested data including Logical Block Addresses and Logical Block Counts are stored as an extent list in non-volatile memory. This extent list information is then used on subsequent start-ups to pre-stage the data from the mass storage device into fast memory before it is requested by the host. This technique thereby reduces access times and improves boot performance. The extent list can be merged and manipulated in other ways to ensure that efficient use is made of limited non-volatile memory space.

### RELATED APPLICATIONS

This application claims the benefit of U.S. Provisional Application No. 60/340,344, filed Dec. 14, 2001 and also No. 60/340,656, filed Dec. 14, 2001. The entire teachings of the above applications are incorporated herein by reference.

### BACKGROUND OF THE INVENTION

This invention relates generally to the field of storage controllers, and more particularly to a plug and play apparatus that is cabled between a storage controller and one or more disk drives that are dedicated to improving performance of system start up.

Today computers have relatively fast processors, prodigious amounts of memory and seemingly endless hard disk space. But hard disk drives remain relatively slow or significant access time improvement has not been seen in many years. Drive capacity increases every year, performance becomes even more of a challenge. Indeed, magnetic disk performance has not kept pace with the Moore's Law trend in disk densities B disk capacity has increased nearly 6,000 times over the past four decades, while disk performance has increased only eight times.

Disk drive performance, which is limited by rotational latency and mechanical access delays, is measured in milliseconds while memory access speed is measured in microseconds. To improve system performance it is therefore desirable to decrease the number of disk accesses by keeping frequently referenced blocks of data in memory or by anticipating the blocks that will soon be accessed and pre-fetching them into memory. The practice of maintaining frequently accessed data in high-speed memory avoiding accesses to slower memory or media is called caching. Caching is now a feature of most disk drives and operating systems, and is often implemented in advanced disk controllers, as well.

Common caching techniques include Least Recently Used (LRU) replacement, anticipatory pre-fetch, and write through caching. LRU replacement comes about from realizing that read requests from a host computer resulting in a disk drive access are saved in cache memory in anticipation of the same data being accessed again in the near future. However, since a cache memory is finite in size, it is quickly filled with such read data. Once full, a method is needed whereby the least recently used data is retired from the cache and is replaced with the latest read data. This method is referred to as Least Recently Used replacement. Read accesses are often sequential in nature and various caching methods can be employed to detect such sequentiality in order to pre-fetch the next sequential blocks from storage into the cache so that subsequent sequential access may be service from fast memory. This caching method is referred to as anticipatory pre-fetch. Write data is often referenced shortly after being written to media. Write through caching is therefore employed to save the write data in cache as it is also written safely to storage to improve likely read accesses of that same data. Each of the above cache methods are employed with a goal of reducing disk media access and increasing memory accesses resulting in significant system performance improvement.

Performance benefits can also be realized with caching due to the predictable nature of disk I/O workloads. Most I/O's are reads instead of writes (typically about 80%) and those reads tend to have a high locality of reference, in the sense that reads that happen close to each other in time tend to come from regions of disk that are close to each other in physical proximity. Another predictable pattern is that reads to sequential blocks of a disk tend to be followed by still further sequential read accesses. This behavior can be recognized and optimized through pre-fetch as described earlier. Finally, data written is most likely read during a short period of time after it was written. The aforementioned I/O workload profile tendencies make for an environment in which the likelihood that data will be accessed from high speed cache memory is increasing thereby avoiding disk accesses.

Storage controllers range in size and complexity from a simple Peripheral Component Interconnect (PCI) based Integrated Device Electronics (IDE) adapter in a Personal Computer (PC) to a refrigerator-sized cabinet full of circuitry and disk drives. The primary responsibility of such a controller is to manage Input/Output (I/O) interface command and data traffic between a host Central Processing Unit (CPU) and disk devices. Advanced controllers typically additionally then add protection through mirroring and advanced disk striping techniques. Caching is almost always implemented in high-end RAID controllers to overcome a performance degradation known as the “RAID-5 write penalty”. The amount of cache memory available in low-end disk controllers is typically very small and relatively expensive compared to the subject invention. The target market for caching controllers is typically the SCSI or Fibre channel market which is more costly and out of reach of PC and low-end server users. Caching schemes as used in advanced high-end controllers are very expensive and typically beyond the means of entry level PC and server users.

Certain disk drive manufacturers add memory to a printed circuit board attached to the drive as a speed-matching buffer. Such buffers can be used to alleviate a problem that would otherwise occur as a result of the fact that data transfers to and from a disk drive are much slower than the I/O interface bus between the CPU and the drive. Drive manufacturers often implement caching in this memory. But the amount of this cache is severely limited by space and cost. Drive-vendor implemented caching algorithms are often unreliable or unpredictable so that system integrators and resellers will even disable drive write cache. These drive- and controller-based architectures thus implement caching as a secondary function.

Solid State Disk (SSD) is a performance optimization technique implemented in hardware, but is different than hardware based caching. SSD is implemented by a device that appears as a disk drive, but is actually composed instead entirely of semiconductor memory. Read and write accesses to SSD therefore occur at electronic memory speeds. A battery and hard disk storage are typically provided to protect against data loss in the event of a power outage. The battery and disk device are configured “behind” the semiconductor memory to enable flushing of the contents of the SSD when power is lost.

The amount of memory in an SSD is equal in size to the drive capacity available to the user. In contrast, the size of a cache represents only a portion of the device (typically limited to the number of the “hot” data blocks that applications are expected to need). SSD is therefore very expensive compared to a caching implementation. SSD is typically used in highly specialized environments where a user knows exactly which data may benefit from high-speed memory speed access (e.g., a database paging device). Identifying such data sets that would benefit from an SSD implementation and migrating them to an SSD device is difficult and can become obsolete as workloads evolve over time.

Storage caching is sometimes implemented in software to augment operating system and file system level caching. Software caching implementations are very platform and operating system specific. Such software needs to reside at a relatively low level in the operating system or in file level hierarchy. Unfortunately, this leads to a likely source of resource conflicts, crash-inducing bugs, and possible sources of data corruption. New revisions of operating systems and applications necessitate renewed test and development efforts and possible data reliability issues. The memory allocated for caching by such implementations comes at the expense of the operating system and applications that need to use the very same system memory.

Microsoft, with its ONNOW technology in Windows XP, and Intel with its Instantly Available PC (IAPC) technology, have each shown the need for improved start up or “boot” speeds. These solutions center around improving processor performance, hardware initialization and optimizing the amount and location of data that needs to be read from a disk drive. While these initiatives can provide significant improvement to start times, there is still a large portion of the start process depends upon disk performance. The problem with their so-called sleep/wake paradigm is that Microsoft needs application developers to change their code to be able to handle suspended communication and I/O services. From Microsoft's perspective, the heart of the initiative is a specification for development standards and Quality Assurance practices to ensure compliance. Thus, their goal is more to avoid application crashes and hangs during power mode transitions than to specifically improve the time it takes to do these transitions.

In general, therefore, drive performance is not keeping pace with performance advancements in processor, memory and bus technology. Controller based caching implementations are focused on the high end SCSI and Fiber Channel market and are offered only in conjunction with costly RAID data protection schemes. Solid State Disk implementations are still costly and require expertise to configure for optimal performance. The bulk of worldwide data storage sits on commodity IDE/ATA drives where storage controller based performance improvements have not been realized. System level performance degradation due to rising data consumption and reduced numbers of actuators per GB are expected to continue without further architectural advances.

### SUMMARY OF THE INVENTION

The present invention is a technique for improving start up or boot process performance in a data processing system. The process can be applied to any system that has at least a small portion of non-volatile memory and which accesses a mass storage device for obtaining boot or startup data and program information. The process can therefore be implemented on a wide range of hardware platforms, including disk storage controllers, host platforms and in band storage controller and/or caching apparatus. The software process should be added to the system at a level where it is available to intercept disk input/output requests and reply in kind with its own locally generated and/or cached responses.

The boot process learns the extent of data that is accessed during the start up process. This extent learning process runs independently of the disk drive environment or the operating system software. Thus, for example, the device will work properly even if changes are made to the underlying operating system or disk drive device code.

The extent data learned thereby is then stored in a non-volatile cache memory. In certain embodiments of the invention, the boot extent list is maintained in such a way that during a subsequent power on sequencing, the device can predictably read the referenced extents from the disk into memory. This process, which can occur prior to such data actually being requested by the host CPU, further provides for increase in boot speeds, since data access can then occur as much as possible at the speed of the non-volatile semiconductor memory.

More particularly, during a boot process I/O operations to the disk are logged in a list of extents. The extent information contains starting logical block address information and sequence numbers. After detecting the end of boot process, the extent list is sorted, such as by logical block address. Attempts are made to merge the contents of the extent list, if for example, the reference logical block addresses overlap or are adjacent to one another. Once the extent list has been merged or otherwise updated in this fashion, the extent list information is stored in non volatile memory for use during subsequent boots.

In accordance with other aspects, a usage counter may be included with the extent list information. Each time an extent from a current boot matches an extent in non volatile memory, the usage counter is incremented. However, if an extent in non volatile memory is found not to have been used during the current boot process, its usage counter is decremented by a predetermined factor such as 2. In this manner, a fast decay function is provided for remembered boot data, so that extent data accessed during often during recent boots is given priority over less frequently used accesses. When the usage counter is reduced to zero, the extent can be removed for example, from the non volatile storage and the current boot list can be remerged using the merge rules.

The invention provides advantages over techniques that store the source data itself in non volatile memory, since only the extent list needs to be retained between boot sequences, rather than the actual data itself.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The above and further advantages of the invention may be better understood by referring to the accompanying drawings in which:

FIG. 1 is a top-level diagram for an apparatus for saving and restoring boot data.

FIG. 2 is a logical view of the hardware apparatus.

FIG. 3 is a flow chart of a boot process using meta data caching.

### DETAILED DESCRIPTION OF THE INVENTION

A description of preferred embodiments of the invention follows.

A method according to this invention can be implemented on any hardware apparatus that contains non-volatile memory and uses a mass storage media device such as a disk drive for storing boot or start up data and programs. This includes platforms such as standard disk storage controllers, host (personal computer or workstation) platforms and in-band storage caching apparatuses. The software should be added to the system at a level where it may intercept disk I/O requests and generate its own. In an operating system, this can be implemented in a new virtual driver between the raw mode driver and the operating system. In a storage controller or in-band storage caching apparatus, this can be implemented as an addition to cache algorithms.

In one embodiment, the boot process is implemented on a hardware platform which implements caching methods using embedded software. This hardware platform typically consists of a fast microprocessor (CPU), from about 256 MB to 4 GB or more of relatively fast memory, flash memory for saving embedded code and battery protected non-volatile memory for storing persistent information such as boot data. It also includes host I/O interface control circuitry for communication between disk drives or other mass storage devices and the CPU within a host platform. Other interface and/or control chips and memory may be used for development and testing of the product.

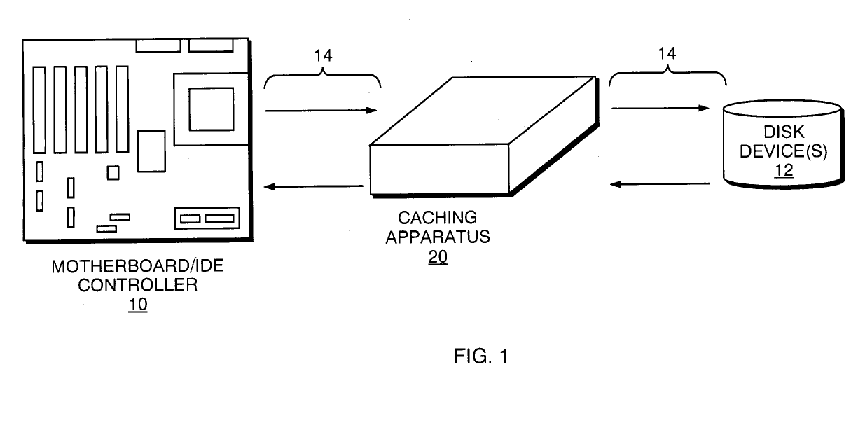

FIG. 1 is a high level diagram illustrating one such hardware platform. The associated host 10 may typically be a Personal computer (PC), workstation or other host data processor. The host as illustrated is a PC motherboard, which includes an integrated device electronic (IDE) disk controller embedded within it. As is well known in the art, the host 10 communicates with mass storage devices such as disk drives 12 via a host bus adapter interface 14. In the illustrated embodiment the host bus adapter interface 14 is an Advanced Technology Attachment (ATA) compatible adapter; however, it should be understood that other host interfaces 14 are possible. In this embodiment, the boot process is implemented on a hardware platform, referred to herein as a cache controller apparatus 20. This apparatus 20 performs caching functions for the system after the boot processing is complete, during normal states of operation. Thus, once boot processing is complete, disk accesses made by the host 10 are first processed by the cache controller 20. The cache controller 20 ensures that if any data requested previously from the disk 12 still resides in memory associated with the cache controller 20, then that request is served from the memory rather than retrieving the data from the disk 12.

The operation of the cache controller 20, including both the caching functions and the boot processing described herein in greater detail below, is transparent to both the host 10 and the disk 12. To the host 10, the cache controller 20 simply appears as an interface to the disk device 12. Likewise, to the disk device 12, the cache controller interface looks as the host 10 would.

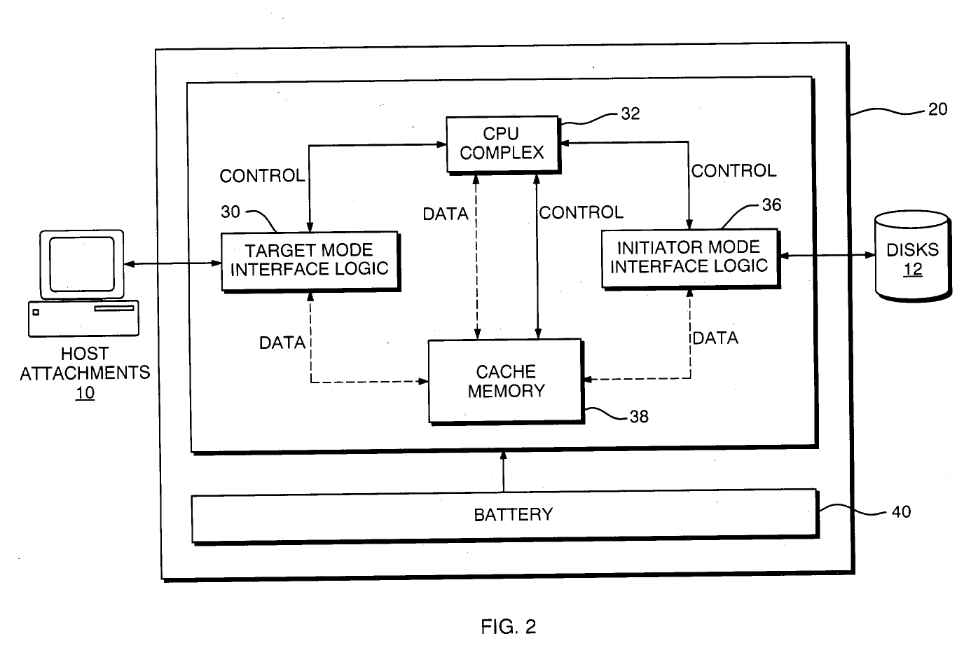

In accordance with the present invention, the cache controller 20 also implements a boot process, for example, during a start up power on sequence. The boot process retrieves boot data from the memory rather than the disk 12 as much as possible. Data may also be predictably checked by the cache controller 20, thereby anticipating access as required by the host 10 prior to their actually being requested. FIG. 2 depicts a logical view of the controller 20. Hosts 10 are attached to the target mode interface 30 on the left side of the diagram. This interface 30 is controlled via the CPU 32 and transfers data between the host 10 and the controller 20. The CPU 32 is responsible for executing the advanced caching algorithms and managing the target and initiator mode interface logic 36. The initiator mode interface logic 36 controls the flow of data between the apparatus 20 and the disk devices 12. It is also managed by the CPU 32. The cache memory 38 is a large amount of RAM that stores host, disk device, and meta data. The cache memory 38 can be thought of as including a number of cache “lines” or “slots”, each slot consisting of a predetermined number of memory locations.

A major differentiator in the controller 20 used for implementing this invention from a standard caching storage controller is that at least some of the memory 38 is protected by a battery 40 in the case of a power loss. The integration of the battery 40 enables the functionality provided by the boot algorithms. The battery is capable of keeping the data for many days without system power.

In a preferred embodiment, a predetermined portion of the total available battery protected cache memory 38 space is reserved for boot extent data. More specifically, a boot process running on the CPU 32, in an initial mode, determines that a system boot is in process and begins recording which data blocks or tracks are accessed from the disk 12. The accessed data is then not only provided to the host 10, but information regarding the logical block addresses of the extent of such data is then preserved in the non-volatile memory 38 for use during subsequent boot processing.

On subsequent start ups, the extent data can be read from the non-volatile memory, and then used to read data from the disk 12 that is expected to be requested during the boot process. Such anticipatory reads may begin while the system is running BIOS level diagnostics such that disk accesses from the host CPU later during the boot sequence can occur at electronic speeds, for significantly faster startup performance.

While the non-volatile memory has been described herein as being co-extensive with the cache 38, but that is not a requirement. The extent data can be stored in a separate small Non-Volatile Random Access Memory (NVRAM) that does not require battery back up, if the cost considerations make sense.

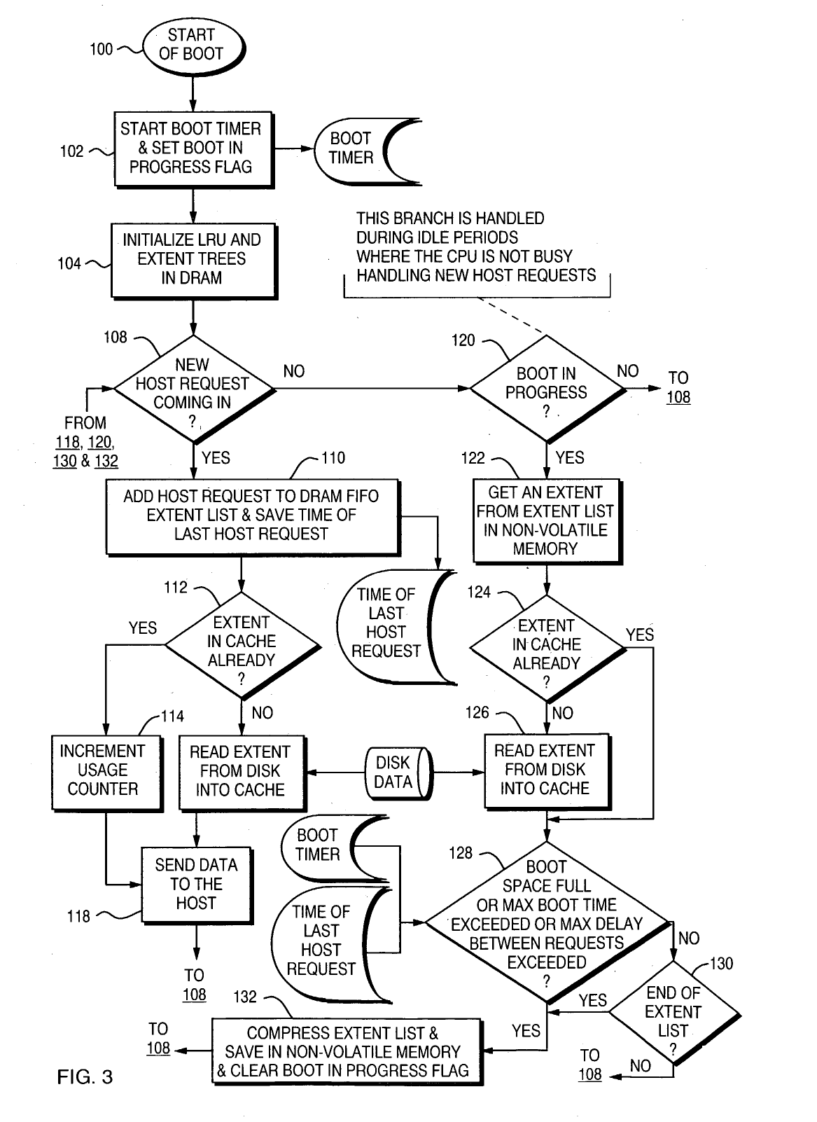

FIG. 3 is a flow diagram of the boot process. From state 100, a boot event is detected by examining local data structures that are not in non-volatile memory and determining they have been initialized and no longer contain the post-boot flags. Once the boot process is detected all I/O operations to the drive(s) are logged in a list of extents. Each extent entry contains a starting Logical Block Address (LBA), an ending LBA for the I/O request, and a sequence number. The sequence numbers are used to help ensure that the extents are read out in the same order in which the host is expected to request them. This particular list is kept in a memory (e.g., Dynamic Random Access Memory) that is not protected by the battery. State 104 initializes this list.

As new host requests are received in state 108, the extent information relating to such a request is stored in the extent list in state 110. If the requested extent is determined in state 112 to already be in the cache, then the usage counter is incremented in state 114. If however, it is not already in the cache, in state 116 the extent is read from the disk 12 into the cache. In any event, the requested data is then sent to the host in state 118. The extent data may contain information associated with the time of last host request and/or the usage counter information as previously described.

A set of instructions beginning at state 120 are executed during times when the CPU is not busy handling new host requests, but a boot is still in progress. Here efforts are made to process extent lists in the background. For example, in state 122, an extent entry is obtained from the extent list as stored in non volatile memory. If, in state 124 it is determined that the referenced extent already exists in the cache, then a state 126 can be skipped. However, if it is not already stored in the memory, then in state 126 the extent may be read from the disk into the cache.

This permits fetching of boot data that is expected to be acquired during that boot process prior to actually being requested from the host. This process can then continue by the comparisons made in state 128 and state 130 as long as the boot space remains available and the end of the extent list has not been reached.

If, however in state 128, the maximum boot time is exceeded or the boot space is full or a delayed timer, for example, is exceeded, then in state 132, it is assumed that the boot process should end. At this point, the extent list can be compressed and then stored in non volatile memory, with the boot-in-process flag being cleared once boot sequence processing is ended.

The end of the boot process can be determined if one of several conditions occurs, depending upon user preference:

1. The maximum time allowed for a boot has been exceeded. This timeout value is 2 minutes, but can be any other valid value or dynamic number.

2. The maximum time allowed between I/O requests by the host platform has been exceeded. This timeout value is 20 seconds but can also be any other valid value or dynamic adjusting value.

3. The amount of memory allocated for building the running extent list from the current process has been filled. This amount of memory is determined by the platform upon which the algorithm is running and its memory limitations and guidelines.

Once the end of the boot has been detected, the extent list will be sorted by starting LBA in state 132. The sorting algorithm will then make successive passes over the extent list to try to merge extents. For example, extents with higher sequence numbers can be merged into those with lower numbered sequences if the sequence numbers can be merged. The requirements for merging sequences are as follows:

1. The sequences intersect at the beginning or end

2. One sequence contains another

3. The gap between the end of one sequence and the beginning of the next is within the tolerance range for gaps. The maximum allowable gap is 64 blocks, but can also be any other valid value or dynamic adjusting number. By allowing for gap merging it is possible to minimize the number of extents that need to be kept in non-volatile memory and to maximize disk performance.

Once sufficient passes have executed to merge all possible extents, and the last pass resulted in no additional merges, the merge process is considered complete. The resulting extent list can then be re-sorted by sequence number if desired.

After the entire non-volatile extent list has been updated, a Cyclic Redundancy Check (CRC) value is calculated and added to the end of the list to provide protection against hardware and software faults that might damage the list. On subsequent boots, the current extent list can also be compared to the one already saved in non-volatile memory, if the CRCs do not match, it can be assumed that the data is corrupt.

Several novel features and advantages of the invention are now apparent. Once such advantage comes about by storing the extent list in non-volatile memory with an additional field that is a usage counter, as in step 114. Each time a comparison of an extent from the current boot matches an extent in non-volatile memory the usage counter is incremented. The usage counter does not overflow since the counter stops incrementing at the maximum number permissible. Each time an extent in non-volatile memory is found not to have been used during the current boot, such as at step 132, its usage counter can be decremented by 2 (or some other factor) to provide for a fast decay function for remembered boot data. By this process data accsssed during recent boots is given priority over previously remembered boot accesses. When the usage counter reaches zero, the extent is removed from non volatile memory (NVD). Extents in the current boot list are merged with extents from the NVD extent list using the same merge rules stated above.

If there are new extents from the current boot that won't fit in the space allocated in the NVD extent list, then extents with low relative usage counters will be found and replaced. For example if an extent's usage counter is 50% below the average usage counter in the list then the extent becomes a candidate for replacement. Preference is given to extents with lower sequence numbers when fitting extents into non-volatile memory to ensure that the beginning of the boot process gets the most benefit.

These methods eliminate the possibility that infrequent boot events (i.e. boots which happen in Windows Safe Mode, or Scan Disk mode, etc. ) will flush the meta data collected during a normal boot process.

The boot process can also start a background pre-stage operation in step 120 to bring in the data from the disk into memory before the host attempts to access it. If the data is already in cache (i.e. has already been requested by the host before the background process got to the extent) then the extent is skipped. Through this technique parallelism is achieved with the CPU during the boot process with the goal of eliminating disk latency delays and improving the boot experience.

In accordance with another aspect of this invention the extent/NVD method can also be used to remember frequently accessed post-boot data such that applications launched after a boot have the benefit of pre-staged data. An example benefit would be getting back to a known state after an application crash and reboot process.

While this invention has been particularly shown and described with references to preferred embodiments thereof, it will be understood by those skilled in the art that various changes in form and details may be made therein without departing from the scope of the invention encompassed by the appended claims.

What is claimed is:

1. A data processing system comprising:
a host central processing unit (CPU);
a mass storage device;
a boot process optimizer that learns the extent of data that is accessed during a start up process, and stores that extent data in a non-volatile memory, such that on subsequent start up processes, the extent data can be used to predictively read data from the mass storage device into memory prior to their being requested by the host CPU.

2. An apparatus as in claim 1 wherein the extent data are further processed to merge adjacent extents and/or overlapping extents into contiguous extent data.

3. An apparatus as in claim 1 additionally comprising:
means for reserving a region of a battery backed up memory as the non volatile memory for extent data.

4. An apparatus as in claim 1 wherein the boot process optimizer is implemented in dedicated disk controller hardware.

5. An apparatus as in claim 1 wherein the boot process optimizer is implemented in a host computer as a filter driver.

6. An apparatus as in claim 1 wherein the extent data is not known prior to at least one boot process, and is read during at least one initial boot processes, so that the implementation of the boot process optimizer is operating system independent.

7. An apparatus as in claim 1 wherein the boot extents are determined to be read requests from the host CPU to the mass storage device that occurs during a finite amount of time after a power on event.

8. An apparatus as in claim 1 wherein the mass storage device is a disk drive.

9. An apparatus as in claim 1 wherein a usage counter is included with the extent data.

10. An apparatus as in claim 9 wherein each time that extent data from a current boot matches extent data read from non volatile memory, the usage counter is incremented.

11. An apparatus as in claim 10 wherein if an extent in non volatile memory is found not to have been used during a current boot process, its respective usage counter is decremented by a predetermined factor.

12. An apparatus as in claim 11 wherein the amount by which the usage counter is incremented is greater than the amount by which the usage counter is decremented, so that more frequently accessed extent data is given priority over less frequently accessed extent data.

13. An apparatus as in claim 10 wherein if the usage counter is reduced to a predetermined value, the corresponding extent data is removed from the non volatile memory.

14. An apparatus as in claim 1 wherein the non volatile memory is a battery back up memory.

15. An apparatus as in claim 1 wherein the non volatile memory is a semiconductor Non Volatile Random Access Memory (NVRAM).

16. An apparatus as in claim 1 wherein the boot extent data is operating system data.

17. An apparatus as in claim 1 wherein the boot extent is application program data.

18. An apparatus as in claim 1 wherein the boot extent data is host CPU and operating system independent.
